(19) United States
(12) Patent Application Publication
(10) Pub. No.: US 2004/0181654 A1
(43) Pub. Date: Sep. 16, 2004

(54) LOW POWER BRANCH PREDICTION TARGET BUFFER

(76) Inventor: Chung-Hui Chen, Hsin-Chu Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,040

(22) Filed: Mar. 11, 2003

(51) Int. Cl. G06F 9/44

(52) U.S. Cl. 712/239

(57) ABSTRACT

30A pipelined central processing unit (CPU) is provided with circuitry that detects branch prediction enabling information encoded within instructions fetched by the CPU. The CPU turns branch prediction circuitry on and off for an instruction based upon the branch prediction enabling information obtained from a previously fetched instruction. Program code instructions are thus each provided appropriate branch prediction enabling information to turn on the branch prediction circuitry only when required by a subsequent branch instruction.

### BACKGROUND OF INVENTION

1. Field of the Invention

The present invention relates to power saving methods for central processing units (CPUs). More specifically, a method is disclosed for reducing power consumption in a branch target buffer (BTB) within a CPU.

2. Description of the Prior Art

Numerous methods have been developed to increase the computing power of central processing units (CPUs). One development that has gained wide use is the concept of instruction pipelines. The use of such pipelines necessarily requires some type of instruction branch prediction so as to prevent pipeline stalls. Various methods may be employed to perform branch prediction. For example, U.S. Pat. No. 6,263,427B1 to Sean P. Cummins et al., included herein by reference, discloses a branch target buffer (BTB) that is used to index possible branch instructions and to obtain corresponding target addresses and history information.

Please refer to FIG. 1. FIG. 1 is a simple block diagram of a prior art pipelined CPU 10. The CPU 10 is for exemplary purposes only, and so for simplicity has only four pipeline stages: an instruction fetch (IF) stage 20, a decode (DE) stage 30, an execution (EX) stage 40 and a write-back (WB) stage 50. The IF stage 20 performs both instruction fetching and dynamic branch prediction, utilizing an instruction cache 24 and branch prediction circuitry 22, respectively, to perform these functions. The DE stage 30 performs decoding of fetched instructions, decoding the instructions themselves, as well as their operands, addresses and the like. The EX stage 40 executes decoded instructions. Finally, the WB stage 50 writes back results obtained from executed instructions, the results being written to both registers and memory. Also, the WB stage 50 is responsible for updating the branch prediction circuit 22.

The branch prediction circuit 22 typically includes branch target buffer (BTB) memory 22b and a TAG memory 22t. An IF address (IFA) register 26 holds the address of an instruction being processed by the IF stage 20. The branch prediction circuit 22 generates a target address (TA) 28 that is computed to be the next instruction that will be executed immediately after the instruction pointed to by the IFA 26. The low order bits of the IFA 26 are used to index into the TAG memory 22t to determine if there is an instruction hit within the BTB memory 22b. The TAG memory 22t simply holds the high order bits of addresses that have branch prediction data in the BTB memory 22b, and in this manner a hit in the BTB memory 22b is determined. Both the BTB memory 22b and the TAG memory 22t may be thought of as separate regions of a common memory block. That is, both the BTB 22b and the TAG 22t must be enabled for either to be utilized effectively, and so in the prior art both are continuously enabled. The BTB 22b includes history information 22h that is used to perform branch prediction for the instruction pointed to by the IFA 26. This history information 22h is updated by the WB stage 50.

The IF stage 20 also utilizes the IFA 26 to actually fetch the instruction from the instruction cache 24. In a next clock cycle of the CPU 10, the IF stage 20 updates the IFA 26 with the contents of the TA 28, and the fetched instruction is passed on to the DE stage 30. As a consequence of this, if the instruction pointed to by the IFA 26 has no entry within the BTB 22b, and thus branch prediction cannot be performed, the branch prediction circuit has a default value predictor 29 to generate a default value for the TA register 28. This default value is simply given as, in terms of instruction space, TA=IFA+1. That is, the TA register 28 is set to point to an instruction that immediately follows the instruction pointed to by the IFA 26. Hence, the term “IFA+1” is meant to indicate a one instruction displacement from the IFA 26 in the instruction execution path. Depending upon the implementation of the instruction set of the CPU 10, this may require that after the instruction is fetched, the default value predictor 29 processes the instruction to obtain a memory displacement off of the IFA 26 to generate the value held by the TA 38. For example, for certain instructions a six byte displacement may be required to get to the immediately subsequent instruction, whereas other instructions may require only a four byte displacement, and yet others an eight byte displacement. Thus, in terms of the actual memory space, the default value predictor 29 generates a value for the TA register 28 as, “TA=IFA+n”, where “n” is the size of the complete instruction currently pointed to by the IFA 26.

Dynamic branch prediction, which involves the use of the BTB memory 22b, is implemented because it reduces pipeline flushes that are incurred when branch prediction fails. That is, it is certainly possible to implement the simplest type of branch prediction, which assumes that branches always occur, or that branches never occur. However, such prediction leads to a greater number of pipeline flushes, when it is learned at the EX stage 40 that the prediction was incorrect, and hence instructions at the DE stage 30 and IF stage 20 must be flushed. These pipeline flushes are expensive, computationally, slowing down the performance of the CPU 10, and so are to be avoided if at all possible: Hence, the current trend is to use dynamic branch prediction, which considerably reduces pipeline flushes. However, the BTB memory 22b can be quite large, including both the TAG data 22t and the history information 22h. The very size of the BTB memory 22b leads to a considerable power load, thereby increasing the current drawn by the CPU 10, which is an undesirable characteristic.

### SUMMARY OF INVENTION

It is therefore a primary objective of this invention to provide a method for reducing power consumption in a pipelined central processing unit by reducing the power consumed by the branch prediction circuitry.

It is a further objective of this invention to provide a method that generates program code for a CPU that utilizes the present invention power reduction method, the program code so generated reducing the power consumed by the CPU when executed by the CPU.

Briefly summarized, the preferred embodiment of the present invention discloses a method for reducing power consumption in a pipelined central processing unit (CPU). The pipelined CPU includes a first stage for performing instruction fetch and branch prediction operations, and a second stage for subsequently processing instructions fetched by the first stage. The branch prediction operation is performed by branch prediction circuitry. A first instruction is fetched by the first stage. Branch prediction enabling information is extracted from the first instruction. The first instruction is then passed on to the second stage. The branch prediction circuitry is enabled or disabled for a second instruction, the second instruction being subsequent to the first instruction. The branch prediction circuitry is enabled or disabled according to the branch prediction enabling information obtained from the first instruction.

Program code that employs the present invention CPU to reduce power consumed by the CPU is generated from code containing regular instructions, or instructions in a default state that is optimized for certain characteristics. A branch instruction is identified in the instructions. A first instruction that is prior to the branch instruction is identified in the execution path of the instructions. The first instruction is provided with encoded branch prediction enabling information that enables the branch prediction circuitry for the branch instruction. Similarly, a non-branch instruction is identified that does not require branch prediction. A second instruction that is prior to the non-branch instruction is identified in the execution path of the instructions. The second instruction is provided with encoded branch prediction enabling information that disables the branch prediction circuitry for the non-branch instruction.

It is an advantage of the present invention that by encoding enabling of the branch prediction circuitry directly into the instructions executed by the CPU, the first stage can selectively turn branch prediction on and off as required, without sacrificing the gains inherent from dynamic branch prediction. When turned off, the branch prediction circuitry consumes very little power, and this leads to a considerable reduction in the total power consumed by the CPU. Branch prediction is enabled on an as-needed basis to provide maximum CPU performance with a minimum power drain.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a simple block diagram of a prior art pipelined central processing unit (CPU).

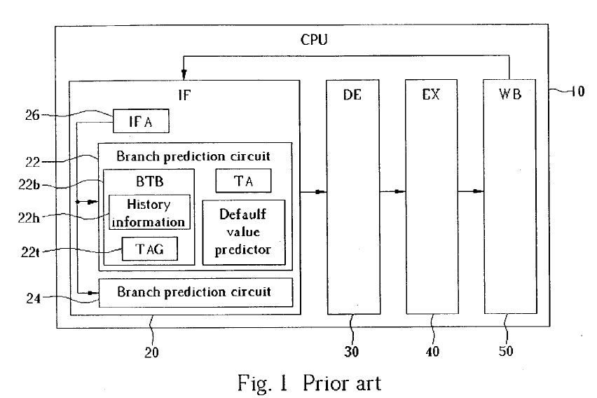

FIG. 2 is a simple block diagram of an example CPU according to the present invention method.

FIG. 3 is a bit-block diagram of an instruction containing branch prediction enabling information according to the present invention.

### DETAILED DESCRIPTION

Although the present invention particularly deals with dynamic branch prediction, it will be appreciated that many methods exist to perform the actual branch prediction algorithm. Typically, these methods involve the use of a branch table buffer (BTB) and associated indexing and processing circuitry to obtain a next instruction address (i.e., a target address). It is beyond the intended scope of this invention to detail the inner workings of such specific dynamic branch prediction circuitry, and the utilization of conventional dynamic branch prediction circuitry may be assumed in this case, except where differences are noted in the detailed description. Additionally, it may be assumed that the present invention pipeline interfaces in a conventional manner with external circuitry to enable the fetching of instructions (as from a cache/bus arrangement), and the fetching of localized data (as from the BTB).

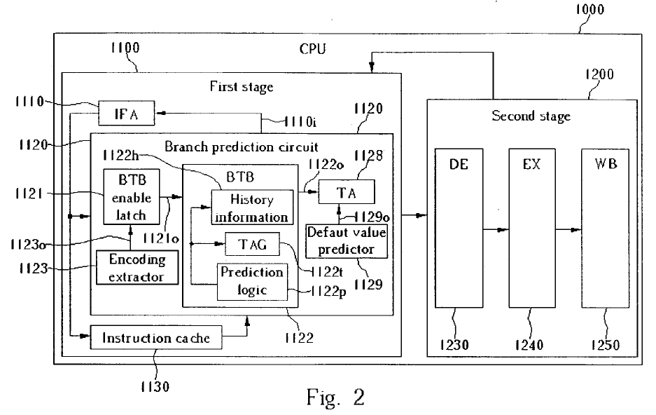

Please refer to FIG. 2. FIG. 2 is a simple block diagram of an example CPU 1000 according to the present invention method. For purposes of explaining the present invention, it is convenient to divide the pipeline of the CPU 1000 into two distinct “stages”: a first stage 1100 and a second stage 1200. It is the job of the first stage 1100 to perform instruction fetching and dynamic branch prediction operations. Upon completion of this, a fetched instruction is then passed on to the second stage 1200 for subsequent processing. Keeping with the example processor 10 of the prior art, the second stage 1200 is actually a logical grouping of three distinct stages: a decode (DE) stage 1230, an execution (EX) stage 1240 and a write-back (WB) stage 1250. Of course, it is possible for the second stage 1200 to have a greater or lesser number of internal stages, depending upon the design of the CPU 1000. The first stage 1100 is analogous to the instruction fetch (IF) stage 20 of the prior art CPU 10, but with modifications to implement the present invention method. However, it should be understood that the first stage 1100 may also be a logical grouping of more than one stage. How this may affect implementing the present invention method should become clear to one reasonably skilled in the art after the following detailed discussion.

The first stage 1100 includes an instruction fetch address (IFA) register 1110, which contains the address of the instruction that is to be branch predicted and fetched by the first stage 1100. The first stage 1100 contains a branch prediction circuit 1120 for performing the branch prediction functionality, and an instruction cache 1130 for performing the instruction fetch functionality. Both the branch prediction circuit 1120 and the instruction cache 1130 utilize the contents of the IFA register 1110 to perform branch prediction and instruction fetching, respectively.

The branch prediction circuit 1120 has been modified over the prior art to support the extraction of branch prediction enabling information that is embedded in the instructions being fetched. Each instruction is potentially encoded with branch prediction enabling information that instructs the CPU 1000 as to whether branch prediction should be enabled or disabled for a subsequent instruction. In the preferred embodiment, the subsequent instruction is one that is immediately fetched after the current instruction whose address is contained in the IFA register 1110. It is the job of an encoding extractor 1123 to obtain this branch prediction enabling information, and to provide the branch prediction enabling information, or a default value, on a BTB enabling/disabling signal line 1123o.

The branch prediction circuit 120 includes a branch target buffer (BTB) 1122. The BTB 1122 includes history information memory 1122h, TAG memory 1122t, and prediction logic 1122p, all of which are equivalent to the prior art. The prediction logic 1122p utilizes the IFA 1110 to index into the TAG memory 1122t to determine if there is a hit within the history information memory 1122h for the instruction pointed to by the IFA 1110. If there is a hit, the prediction logic 1122p utilizes the history information memory 1122h to obtain a predicted target address, and to provide the predicted target address on branch prediction output lines 1122o. The branch prediction output lines 1122o feed into target address (TA) circuitry 1128, which in turn feeds back into the IFA 1110 to provide a next address for the first stage 1100. A default value predictor 1129 generates a default next address as explained in the description of the prior art, and which is given in execution space as IFA+1, feeding this default address into the TA circuit 1128 via default output lines 1129o. The TA circuit 1128 selects either the predicted target address present on the branch prediction output lines 1122o, or the default next address present on the default output lines 1129o, to serve as an input target address 1110i feeding into the IFA latch 1110. If the branch prediction output lines 11220 indicate that the BTB 1122 has generated a valid address, then the TA circuit 1128 selects the predicted target address present on the branch prediction output lines 1122o. If no valid address is forthcoming from the BTB 1122, though, then the TA circuit 1128 selects the default next address present on the default output lines 1129o.

The encoding extractor 1123 generates a BTB enabling/disabling signal 1123o according to branch prediction enabling information encoded within the currently fetched instruction, i.e., the instruction fetched from the address contained in the IFA 1110. Just as the default value predictor 1129 requires a fetched instruction so as to generate the default output 1129o, so too does the encoding extractor 123 require the fetched instruction to generate the BTB enabling/disabling signal 123o. How the encoding extractor 1123 obtains branch prediction enabling information from a fetched instruction to generate the BTB enabling/disabling signal 1123o is explained later. This BTB enabling/disabling signal 1123o is latched by a BTB enable latch 1121, and sent to the BTB circuit 1122 at the beginning of the next CPU 1000 clock cycle by way of a BTB enable line 11210. The BTB enable line 11210 either enables or disables the BTB circuit 1122, and does so according to the branch prediction enabling information extracted from the previously fetched instruction (with respect to the current clock cycle being processed by the first stage 1100). In particular, both the history information memory 1122h and the TAG memory 1122t are enabled or disabled by the BTB enable line 11210. It is also desirable to have the prediction logic 1122p enabled or disabled according to the BTB enable line 1121o. When enabled by the BTB enable line 11210, the BTB circuit 1122 functions like a prior art BTB circuit, and hence draws the power that the prior art BTB circuit draws. However, when disabled by the BTB enable line 11210, the BTB circuit 1122 draws very little power; such power being primarily the result of leakage current. Hence, by disabling the BTB circuit 1122, a considerable savings of power is obtained. When the BTB circuit 1122 is disabled by the BTB enable line 11210, the TA 1128 ignores the branch prediction output lines 1122o, and instead selects the default output lines 1129o to provide the target address to the IFA 1100 via input target address lines 1110i, which is then latched into the IFA 1110 on the next CPU 1000 pipeline clock cycle. Hence, information about the BTB enable line 11210 must be provided to the TA circuit 1128, either directly from the BTB enable latch 1121, or along the branch prediction output lines 1122o. In FIG. 2 it is assumed that data on the BTB enable line 11210 is forwarded to the TA circuit 1128 by way of the branch prediction output lines 1122o.

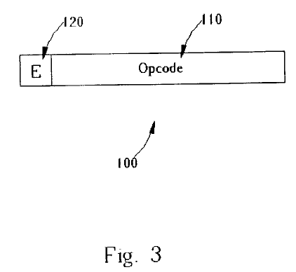

Various methods may be used to encode the branch prediction enabling information into the instructions that are fetched by the first stage 1100 and then processed by the encoding extractor 1123 to generate the BTB enabling/disabling signal 1123o. The simplest method is depicted in FIG. 3. Please refer to FIG. 3 in conjunction with FIG. 2. FIG. 3 is a bit block diagram of an instruction 100 containing branch prediction enabling information according to the present invention. The instruction 100 contains an opcode field 110 that specifies the instruction type, e.g., an addition operation (ADD), an XOR operation (XOR), a memory/register data move operation (MOV), etc. The nature and use of such an opcode field 110 is well known in the art. However, the instruction 100 is additionally provided a single BTB enable bit 120. The state of the BTB enable bit 120 corresponds to the state of the BTB enabling/disabling signal line 1123o. In this case, the encoding extractor 1123 does nothing more than present the BTB enable bit 120 (or its logical inversion) on the BTB enabling/disabling signal line 11230, and hence is exceedingly easy to implement. The drawback to this method is that it effectively cuts in half the total number of opcodes present in an instruction 100, there being in effect two copies for every opcode: one to enable the BTB 1122, and another to disable the BTB 1122. Many designers might consider this wasteful of the opcode “resource”.

As an alternative method, rather than providing a dedicated BTB enable bit 120, the CPU 1000 instruction set may simply provide only certain selected instructions with two versions of the instruction (a BTB 1122 enable version, and a BTB 1122 disable version). For example, in almost all instruction sets, there are opcodes that are unused, and hence illegal. Each of these illegal opcodes could instead be used to support an alternative version of a present opcode. Ideally, opcodes that are duplicated should be those that are most commonly used in program code. Those opcodes that are not duplicated will, when processed by the encoding extractor 1123, generate a default state for the BTB enabling/disabling signal line 1123o. If the CPU 1000 is to be optimized for speed, then the default state should cause the BTB enabling/disabling signal line 1123o to enable the BTB circuitry 1122. If, on the other hand, the CPU 1000 is to be optimized for power-savings, then the default state for the BTB enabling/disabling signal line 11230 should be one that disables the BTB circuit 1122. It is certainly possible to provide instructions that set or change the default state, i.e., to make the default state of the BTB enabling/disabling signal line 1123o programmable.

As an example of the above branch prediction encoding method, consider a CPU that is to be provided with the present invention power savings method, and which initially has an instruction “MOV reg, reg”. This instruction moves data from one register to anther register in the CPU, and is one of the most commonly used instructions. Assume that this “MOV” instruction has an opcode value of Ox62 (hexadecimal). Further assume that for the CPU, the opcode value of 0×63 was initially illegal. Two versions of the “MOV reg, reg” instruction may now be made available: the first, “MOV_e reg, reg” can be given an opcode value of 0×62, behaves like the initial “MOV reg, reg” instruction, but in addition when processed by the encoding extractor 1123 causes the BTB enabling/disabling signal line 123o to enable the BTB circuit 1122. The second, “MOV_d reg, reg” can be given the opcode value of 0×63, behaves like the initial “MOV reg, reg” instruction, but in addition when processed by the encoding extractor 1123 causes the BTB enabling/disabling signal line 1123o to disable the BTB circuit 1122. The number of opcodes that can be duplicated in this manner is limited only by the number of initially unused (i.e., illegal) opcodes. As previously stated, those opcodes that are not duplicated simply cause the encoding extractor 1123 to generate a default value on the BTB enabling/disabling signal line 1123o. Although this method maximizes use of the CPU opcode “resource”, this method also makes for a somewhat more complicated encoding extractor 1123. For example, the encoding extractor 1123 may now require a lookup table, using the opcode as an index, to generate the output on the BTB enabling/disabling signal line 1123o. The design of such an encoding extractor 1123 should be a trivial matter for one reasonably skilled in the art.

To understand how the present invention achieves power savings by disabling the BTB circuit 1122 without sacrificing the benefits to CPU speed afforded by a functional BTB circuit 1122, consider the following table of program code:

TABLE 1

| | | | Branch |
|---|---|---|---|
| | | | prediction |
| | | | enabling |
| Target | Instruction | Destination | information |
| | Ins_1 | | Disable |
| | Ins_2 | | Enable |
| | Bra_1 | label_1 | Disable |
| | Ins_3 | | Disable |
| | Ins_4 | | Disable |
| | Ins_5 | | Disable |
| | Ins_6 | | Disable |
| label_1 | Ins_7 | | Disable |
| | Ins_8 | | Disable |

In the above, instructions Ins_{—}1 to Ins_{—}8 are assumed to be non-branch instructions, such as MOV, XOR, ADD or the like. That is, instructions Ins_{—}1 to Ins_{—}8 are instructions whose execution path flow can be accurately predicted by the default value predictor 1129. Instruction Bra_{—}1 is considered to be a branch instruction, such as a non-conditional jump, a conditional jump, a sub-routine call, a sub-routine return, and the like (i.e., any instruction that breaks from an execution path flow that can be accurately provided by the default value predictor 1129). Assume that when the address for instruction Ins_{—}1 is clocked into the IFA 1110, at the same time a disabling value is present on the BTB enabling/disabling signal line 1123o and clocked into the BTB enable latch 1121. As a result, the BTB circuit 1122 is disabled during the processing of the instruction Ins_{—}1 in the first stage 1100. Instruction Ins_{—}1 thus consumes less power than would be consumed in an equivalent prior art CPU. The encoding extractor 1123 extracts a disable value from instruction Ins_{—}1, and puts this disable value on the BTB enabling/disabling signal line 11230. Since the BTB circuit 1122 is disabled, the TA circuit 1128 uses the default address 1129o from the default value predictor 1129, which is the address for Ins_{—}2, and places this address value onto the input target address lines 1110i. In the next clock cycle, the address for Ins_{—}2 is clocked into the IFA 1110 from the input target address lines 1110i, and the disable signal on the BTB enabling/disabling signal line 1123o is clocked into the BTB enable latch 1121, again disabling the BTB circuit 1122. Instruction Ins_{—}2, however, is encoded with an enable signal in the branch prediction enabling information. Encoding extractor 1123 thus places an enable value on the BTB enabling/disabling signal line 11230. The BTB circuit 1122 is not immediately enabled, however, as the BTB enabling/disabling signal line 1123o is not clocked into the BTB enable latch 1121 until the next clock cycle. Again, the TA circuit 1128 utilizes the default value predictor 1129, since the BTB circuit 1122 is disabled, which generates the address for instruction Bra_{—}1. Instruction Bra₁₃ 1 is a branch instruction, and so requires branch prediction. In the next clock cycle, the enable value present on the BTB enabling/disabling signal line 1123o, which was derived from the branch prediction enabling information present in instruction Ins_{—}2, is clocked into the BTB enable latch 1121, which consequently enables the BTB circuit 1122. In particular, the history information memory 1122h and the TAG memory 1122t are enabled, as well as the prediction logic 1122p. The BTB circuit 1122 begins to draw more power, but also performs branch prediction for the instruction Bra_{—}1. Encoding extractor 1123 obtains a disable value from the branch prediction enabling information encoded within the instruction Bra_{—}1, and places this disable value on the BTB enabling/disabling signal line 1123o. However, the BTB circuit 1122 is not immediately disabled, as the BTB enabling/disabling signal line 1123o is not clocked into the BTB enable latch 1121 until the next clock cycle. Hence, a complete cycle of branch prediction is performed for instruction Bra₁₃ 1. Assume that Bra_{—}1 is present in the TAG memory 1122t, and that the BTB circuit 1122 thereby generates a branch predicted target address of “label_{—}1”, i.e., the address of Ins_{—}7. This branch predicted target address is placed upon the branch prediction output lines 1122o, and subsequently selected by the TA circuit 1128 for the input target address 1110i. In a next clock cycle, the IFA register 1110 latches in the address for instruction Ins_{—}7, and latches in the disable value present on the BTB enabling/disabling signal line 1123o, which was extracted from instruction Bra_{—}1. Consequently, for instruction Ins_{—}7 the BTB circuit 1122 is disabled, and so the input target address 1110i is obtained from the default value predictor 1129. In short, for the four instructions executed (Ins_{—}1, Ins_{—}2, Bra_{—}1, Ins_{—}7), the BTB circuitry 1122 is enabled for only one (Bra₁₃ 1). Consequently, power savings is obtained for three of the four instructions (Ins_{—}1, Ins_{—}2 and Ins_{—}3), while retaining dynamic branch prediction functionality for those functions that require it, e.g., Bra_{—}1.

In the event that a target branch address of a first branch instruction is itself a second branch instruction, the first branch instruction can be set to have branch prediction enabling information that enables the BTB circuit 1122. As an example of this, consider the following table of program code:

TABLE 2

| | | | Branch |
|---|---|---|---|
| | | | prediction |
| | | | enabling |
| Target | Instruction | Destination | information |
| | Ins_1a | | Disable |
| | Ins_2a | | Enable |
| | Bra_1a | label_1a | Enable |
| | Ins_3a | | Disable |
| | Ins_4a | | Disable |
| | Ins_5a | | Disable |
| | Ins_6a | | Enable |
| label_1a | Bra_2a | label_2a | Disable |
| | Ins_8a | | Disable |
| label_2a | Ins_9a | | Disable |

In Table 2, instructions Ins_{—}1a to Ins_{—}9a are assumed to be non-branch instructions, whereas instructions Bra_{—}1a and Bra_{—}2a are assumed to be branch instructions. Assume that the execution flow path of the CPU 1000 for the code in the above Table 2 proceeds as Ins_{—}1a, Ins_{—}2a, Bra_{—}1a, Bra_{—}2a, and finally Ins_{—}9a. Table 3 below provides a brief summary of the BTB circuitry 1122 enabling state for each instruction in the execution flow path of the code in FIG. 2.

TABLE 3

| | Branch | | |
|---|---|---|---|
| | prediction | | |
| Instruction | enabling | BTB enable | |
| pointed to by | information | line 1121□ | TA 1128 |
| IFA 1110 | 1123□ | state | selection |
| Ins_1a | Disable | Disable | Default |
| | | | predictor |
| | | | 1129□ |
| Ins_2a | Enable | Disable | Default |
| | | | predictor |
| | | | 1129□ |
| Bra_1a | Enable | Enable | BTB 1122□ |
| Bra_2a | Disable | Enable | BTB 1122□ |
| Ins_9a | Disable | Disable | Default |
| | | | predictor |
| | | | 1129□ |

As in the previous example with Table 1, it is assumed that the BTB enable latch 1121 holds a disabling value for the BTB circuit 1122 with regards to the instruction Ins_{—}1a. As can be seen from Tables 2 and 3, the majority of instructions are encoded so that the BTB circuit 1122 is subsequently disabled, thus providing significant power savings. Only a few of the instructions (such as Ins_{—}2a and Bra_{—}1 a) are encoded to subsequently turn on the BTB circuit 1129. However, by properly selecting the correct few instructions, dynamic branch prediction is provided for all branch instructions, regardless of the execution flow path, while keeping the BTB circuitry 1122 disabled for those instructions that do not require branch prediction, and hence saving power during the processing of those instructions. With program code containing properly embedded branch prediction enabling information, CPU 1000 processing speed can be maintained, while enjoying the benefits of reduced power consumption by having the BTB circuitry disabled for a significant percentage of the executed instructions. In typical program code, only about 20% of the instructions are branch-related, and so require branch prediction. The other 80% are non-branch related instructions, and the execution flow path can be accurately predicted for these non-branching instructions by the default value predictor 1129. Hence, in typical program code containing properly placed branch prediction enabling information, up to an 80% savings in BTB circuitry 1122 related power consumption can be obtained by the present invention.

A method is outlined that may be used to encode program instructions with branch prediction enabling information. Of course, any instruction that does not intrinsically support the encoding of branch prediction enabling information does not need to be considered, as it is provided a default BTB enabling value from the encoding extractor 1123, as explained previously. For the sake of simplicity in the following, all instructions are assumed to support the explicit embedding of branch prediction enabling information, however such information is encoded, also as previously explained.

By way of example, consider the program code of Table 2. As a first step, all branch prediction enabling information is initialized to “disabled”, yielding the following:

TABLE 4

| | | | Branch |
|---|---|---|---|
| | | | prediction |
| | | | enabling |
| Target | Instruction | Destination | information |
| | Ins_1a | | Disable |
| | Ins_2a | | Disable |
| | Bra_1a | label_1a | Disable |
| | Ins_3a | | Disable |
| | Ins_4a | | Disable |
| | Ins_5a | | Disable |
| | Ins_6a | | Disable |
| label_1a | Bra_2a | label_2a | Disable |
| | Ins_8a | | Disable |
| label_2a | Ins_9a | | Disable |

At this point, the above code in Table 4 is optimized for power-savings at the expense of CPU 1000 execution speeds. Next, all branch instructions are identified in the program code. These branch instructions include Bra_{—}1a and Bra_{—}2a. Identifying branch-related instructions is a trivial matter for those in the art of designing compilers, assemblers and linkers. A tag set is then generated that contains all instructions that are immediately before the identified branch instructions in any potential execution path. This skill is well known to those in the art of designing compilers and debuggers, is termed referencing, and is frequently used to identify “dead” portions of code that cannot be reached by any execution path. Hence, identifying instructions that lie immediately before the branch instructions in a potential execution path is a relatively trivial task given the current state of compilers, assemblers, linkers and debuggers. For example, instruction Ins_{—}2a lies immediately before branch instruction Bra_{—}1a, and must lead to the execution of Bra_{—}1s if executed. Hence, instruction Ins_{—}2a is added to the tag set. Similarly, instruction Ins_{—}6a is added to the tag set as it lies before branch instruction Bra_{—}2a. Because branch instruction Bra_{—}1a has an explicit reference to branch instruction Bra_{—}2a (via label label_{—}1a), branch instruction Bra_{—}1a can potentially be immediately before branch instruction Bra_{—}2a in the execution path, and so is added to the tag set. Each instruction in the tag set, which for the current example includes Ins_{—}2a, Ins_{—}6a and Bra_{—}1 a, is then modified to contain branch prediction enabling information that enables the BTB circuit 1122. This yields the code that is depicted in Table 2, and which maximizes CPU 1000 performance while keeping the power drawn by the BTB circuit 1122 to a minimum.

For certain types of program code it may be unclear at compile/assemble time as to what the target address is of a branch instruction. For example, in Table 4, branch instruction Bra_{—}1a explicitly makes reference to branch instruction Bra_{—}2a, and so determining that instruction Bra_{—}1a should enable the BTB circuit 1122 is straightforward. However, other branch instructions may jump through registers or memory locations, and so their target address is determined at runtime. Where the target address of a branch instruction cannot be determined at compile/assemble time, a default value must be provided for the branch prediction enabling information for the branch instruction. If optimizing for speed, this default value should enable the BTB circuit 1122. If optimizing for power-savings, the default value should disable the BTB circuit 1122. Of course, if it can be determined that the execution path of a first branch instruction potentially leads immediately to a second branch instruction, then branch prediction enabling information for this first branch instruction should always enable the BTB circuit 1122.

As a minor deviation from the above method, instructions can be assigned branch prediction enabling information on an instruction-by-instruction basis. As an example of this, consider the following code:

TABLE 5

| | | | Branch |
|---|---|---|---|
| | | | prediction |
| | | | enabling |
| Target | Instruction | Destination | information |
| | Ins_1a | | n/a |
| | Ins_2a | | n/a |
| | Bra_1a | label_1a | n/a |
| | Ins_3a | | n/a |
| | Ins_4a | | n/a |
| | Ins_5a | | n/a |
| | Ins_6a | | n/a |
| label_1a | Bra_2a | label_2a | n/a |
| | Ins_8a | | n/a |
| label_2a | Ins_9a | | n/a |

Table 5 is basically identical to Tables 2 and 4, except that the value supplied by the branch prediction enabling information for each instruction is undefined (though it could also be set to a default state if desired). Each instruction in Table 5 is then considered. The order of such consideration is a design choice, and for the present example the instructions are considered from the top to the bottom of Table 5. A first instruction is selected, such as the instruction Ins_{—}2a. A second instruction is then found that lies immediately before the first instruction Ins_{—}2a in the execution path. This second instruction is the instruction Ins_{—}1a. Because both instructions are non-branch instructions, the branch prediction enabling information for instruction Ins_{—}1a is set to disable the BTB circuit 1122. The process is then repeated for another instruction. For example, instruction Bra_{—}1a is selected as the first instruction, and identified as a branch instruction. Instruction Ins_{—}2a is selected as the second instruction, as Ins_{—}2a lies immediately before Bra_{—}1a in the execution path. Because the first instruction Bra_{—}1a is a branch instruction, the branch prediction enabling information for Ins_{—}2a is set to enable the BTB circuit 1122, regardless of whether or not the second instruction Ins_{—}2a is a branch or non-branch instruction. Repeating the process again, instruction Ins_{—}3a is considered as the first instruction. The second instruction is therefore now Bra_{—}1a. Because the second instruction Bra_{—}1a is a branch instruction, some additional processing must be performed. If it can be determined that every potential target address of the second instruction Bra_{—}1a is a non-branch instruction, then the branch prediction enabling information for the second instruction Bra_{—}1a can be set to disable the BTB circuit 1122. However, if even one of the potential targets of the second instruction is found to be a branch instruction, then the branch prediction enabling information for the second instruction Bra_{—}1 a should be set to enable the BTB circuit 1122. The second case is what occurs for this example, and so the branch prediction enabling information for the second instruction Bra_{—}1a is set to enable the BTB circuit 1122. In the event that the target address of the second instruction cannot be determined, a default value as previously explained can be provided for the branch prediction enabling information of the second instruction. Continued iterations of the process will lead to branch prediction enabling information as depicted in Table 2. Note that the most obvious choice for finding any second instruction is to simply pick that instruction that is immediately before the first instruction in the program memory space. However, compilers frequently keep detailed reference lists that can enable quick determination of additional second instructions in addition to the immediately previous instructions. For example, taking Bra_{—}2a as an example first instruction, a compiler will quickly determine that instructions Ins_{—}6a and Bra_{—}1a are second instructions, instruction Bra_{—}1a coming from the compiler-maintained reference list. Hence, both second instructions Ins_{—}6a and Bra_{—}1a will have their branch prediction enabling information set to enable the BTB circuit 1122. Further note that in the above, if an instruction has its branch prediction enabling information set to enable the BTB circuit 1122 by a previous iteration of the method, that instruction should generally not be later modified by a later iteration to have its branch prediction enabling information set to disable the BTB circuit 1122, unless one is optimizing for power-savings at the expense of CPU execution speed.

An immediate benefit is provided to users when using programs encoded according to the above branch prediction enabling information embedding methods, as such programs exhibit power savings while maintaining execution speed. Programs running on the present invention CPU 1000 that do not employ the proper embedding of branch prediction enabling information into their instructions will typically either default to an (a) BTB circuitry 1122 always-enabled state, or (b) BTB circuitry 1122 always-disabled state. For condition (a), the program will cause the CPU 1000 to consume at least as much power as a prior art CPU. Under condition (b) the program will cause the CPU 1000 to consume less power than the prior art CPU, but will almost certainly run slower due to an increased rate of pipeline flushes. By using the above methods to embed into otherwise standard code the branch prediction enabling information of the present invention, a user is immediately and invisibly afforded a more energy efficient CPU 1000, while sacrificing little to nothing in terms of execution speed. Of course, a present invention CPU 1000 is required to enjoy these benefits, but such benefits could potentially be accrued without any effort at all being required of the end-user, apart from utilizing the present invention CPU 1000. That is, depending upon how branch prediction enabling information is embedded into the instructions, it is possible that both old program code, and new program code that employs the present invention method, can run on the present invention CPU 1000. Programs using the present invention method can be distributed in a normal matter by way of magnetic or optical media (or via a network connection), loaded into memory and executed by the CPU 1000, and thereby immediately benefit the user with reduced power consumption rates over equivalent prior art programs.

The above embodiments presuppose that the branch prediction enabling information for a first instruction is provided in a second instruction that is immediately before the first instruction in the execution path. Modifying the CPU 1000 so that branch prediction enabling information is provided in even earlier instructions is possible, though, and is well within the scope of the present invention. For example, the encoding extractor 1123 could be placed within the DE stage 1230. This will induce minor changes to the present invention method for providing the branch prediction enabling information to instructions, but these changes should be well within the abilities of one reasonably skilled in the compiler/assembler design.

In contrast to the prior art, the present invention provides a CPU that is capable of extracting branch prediction enabling information from fetched instructions. This branch prediction enabling information is used to enable or disable branch prediction circuitry for a subsequently fetched instruction. Branch prediction enabling information can be embedded into instructions by way of a compiler, assembler, or explicit hand coding. By properly providing this branch prediction enabling information, power-savings benefits are enjoyed by disabling the branch prediction hardware when it is not required. At the same time, CPU execution speeds are maintained. Providing such embedded branch prediction enabling information requires that branch instructions be identified, and that instructions before them in the execution path be modified to enable the branch prediction hardware. All other instructions can be modified so that their branch prediction enabling information disables the branch prediction hardware. Properly implemented, a program utilizing the present invention method will cause the present invention branch prediction hardware to consume up to 80% less power over the prior art.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for reducing power consumption in a pipelined central processing unit (CPU), the pipelined CPU comprising:
at least a first stage for performing instruction fetch and branch prediction operations, the branch prediction operation employing branch prediction circuitry; and
at least a second stage for processing instructions fetched by the first stage;
the method comprising:
the first stage fetching a first instruction;
obtaining branch prediction enabling information from the first instruction;
passing the first instruction on to the second stage;
enabling or disabling at least a portion of the branch prediction circuitry for a second instruction that is subsequent the first instruction, the branch prediction circuitry enabled or disabled according to the branch prediction enabling information; and
the first stage performing the instruction fetch and branch prediction operations upon the second instruction;
wherein the branch prediction operation is performed upon the second instruction by the branch prediction circuitry according to the branch prediction enabling information encoded within the first instruction.

2. The method of claim 1 wherein the second instruction is fetched immediately after the first instruction.

3. The method of claim 1 wherein the branch prediction circuitry comprises a branch target buffer (BTB), and enabling or disabling the branch prediction circuitry comprises enabling or disabling the branch target buffer, respectively.

4. The method of claim 1 further comprising:
providing a default branch prediction result for the second instruction if the branch prediction circuitry is disabled for the second instruction.

5. The method of claim 4 wherein the default branch prediction result indicates that no branch is taken for the second instruction.

6. The method of claim 1 further comprising:
setting the branch prediction enabling information to a default state if the first instruction is not encoded with the branch prediction enabling information.

7. A central processing unit CPU comprising circuitry for performing the method of claim 1.

8. A method for providing branch prediction enabling information within instructions that are executable by the CPU of claim 7, the method comprising:
identifying a branch instruction in the instructions;
identifying at least one first instruction that is prior to the branch instruction in the execution path of the instructions; and
providing the first instruction with encoded branch prediction enabling information that enables the branch prediction circuitry for the branch instruction.

9. The method of claim 8 further comprising:
identifying a non-branch instruction that does not require branch prediction;
identifying at least one second instruction that is prior to the non-branch instruction in the execution path of the instructions; and
providing the second instruction with encoded branch prediction enabling information that disables the branch prediction circuitry for the non-branch instruction.

10. The method of claim 9 wherein the second instruction is immediately prior to the non-branch instruction in the execution path.

11. The method of claim 8 wherein the first instruction is immediately prior to the branch instruction in the execution path.

12. The method of claim 8 further comprising:
providing each instruction with encoded branch prediction enabling information that disables the branch prediction circuitry for the instruction prior to identifying the branch instruction.

13. A computer readable media comprising program code containing instructions with branch prediction enabling information provided by the method of claim 8.
